(19) United States
(12) Patent Application Publication
(10) Pub. No.: US 2008/0038706 A1
(43) Pub. Date: Feb. 14, 2008

(54) Automated User Education and Training Cognitive Enhancement System

(75) Inventor: Laurie Dameshek, Newtown Square, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., MALVERN, PA (US)

(21) Appl. No.: 11/832,043

(22) Filed: Aug. 1, 2007

Related U.S. Application Data
(60) Provisional application No. 60/821,727, filed on Aug. 8, 2006.
(60) Provisional application No. 60/939,641, filed on May 23, 2007.

(51) Int. Cl. G09B 5/06

(52) U.S. Cl. 434/309

(57) ABSTRACT

A training system employs multiple cognitive components, including saccadic eye movements, bilateral stimulation, visual imagery and verbal cognition, for example, to produce improved educational results using psychological treatment techniques including, for example, Eye Movement Desensitization and Reprocessing (EMDR). A processing device implemented and automated, cognitively enhanced education system includes a display processor for providing data representing at least one display image presenting information to be learnt by a user. A first stimulation generator automatically generates visual data for display in the at least one display image for providing bilateral visual stimulation to the user prompting the user to visually scan the information in the at least one display image in at least one of, (a) a vertical and (b) horizontal, direction. A second stimulation generator automatically generates speech representative data concerning the information for reproduction and provision to the user concurrently with presentation of the information and visual data to the user.

This is a non-provisional application of provisional application Ser. No. 60/821,727 filed Aug. 8, 2006, by L. Dameshek and of provisional application Ser. No. 60/939,641 filed May 23, 2007, by L. Dameshek.

### FIELD OF THE INVENTION

This invention concerns an automated, cognitively enhanced education system involving automatically generating visual data for display prompting a user to visually scan displayed information and automatically generating speech representative data concerning the information.

### BACKGROUND OF THE INVENTION

A student, whether in an educational (primary, secondary or post-secondary) or business setting may need to learn complex new material in a short time. The student may not have an instructor who has the time to present the content and work with the student to ensure comprehension. Such a situation might occur when a sophisticated new product such as a healthcare information system, is delivered to a large organization like a multi-entity healthcare facility, and users have minimal or sporadic use of that product. If training is hard to complete due to schedules of instructors and students, and the risks of making mistakes when using the product are high, a computer-based training (CBT) program is useful in supporting a training requirement. However, given time constraints on a new user, the CBT needs to be effective to be useful. If the risk of potential hazard is great when a new product user is unfamiliar with its operation, which may occur when introducing a new and complex piece of medical equipment to a hospital system, for example, the user of that equipment may experience concern or anxiety if feeling less than fully competent in its use. An effective CBT or simulator may substantially reduce the possibility of this issue arising.

There are known software programs, as well as tutoring techniques, that relate to cognitive processing to improve student understanding and performance in language arts and math, as well as techniques to support introduction and reinforcement of new material in subjects. Environment and activity simulators. e.g., a Flight Simulator software program, also exist to provide virtual experiences to train users in specific skills. These programs lack comprehensive cognitive and educational reinforcement capabilities. Known learning systems have their strengths and weaknesses, which are dependent upon the skills and learning style of a user, as well as the type of material presented. A system is desirable that provides more efficient (i.e., quicker, involving less effort) and effective (providing better results over time) training and supports conveying a broader range of material to a user. A system according to invention principles addresses these deficiencies and related problems.

### SUMMARY OF THE INVENTION

A training system employs multiple cognitive components, including saccadic eye movements, bilateral stimulation, visual imagery and verbal cognition, for example, to structure the placement of new concepts into memory for better storage and retrieval of new material. A processing device implemented and automated, cognitively enhanced education system includes a display processor for providing data representing at least one display image presenting information to be learnt by a user. A first stimulation generator automatically generates visual data for display in the at least one display image for providing bilateral visual stimulation to the user prompting the user to visually scan the information in the at least one display image in at least one of, (a) a vertical and (b) horizontal, direction. In another embodiment as an alternative to bilateral video stimulation, bilateral auditory stimulation (e.g. tapping sound or recorded text) is employed. A second stimulation generator automatically generates speech representative data concerning the information for reproduction and provision to the user concurrently with presentation of the information and visual data to the user.

### BRIEF DESCRIPTION OF THE DRAWING

FIG. 1 shows an automated, cognitively enhanced education system, according to invention principles.

FIG. 2 shows a display image provided by automated, cognitively enhanced education system 10 in which lights scan (i.e., appear to move) horizontally, according to invention principles.

FIG. 3 shows a flowchart of a process employed by an automated, cognitively enhanced education system involving student system interaction, according to invention principles.

FIG. 4 shows a flowchart of a process employed by an automated, cognitively enhanced education system involving teacher interaction for lesson step identification, according to invention principles.

FIG. 5 shows a flowchart of a process employed by an automated, cognitively enhanced education system involving teacher lesson setup interaction, according to invention principles.

FIG. 6 shows another automated, cognitively enhanced education system embodiment, according to invention principles.

### DETAILED DESCRIPTION OF THE INVENTION

An automated, cognitively enhanced education system comprises a training system that employs multiple cognitive components, including saccadic eye movements, bilateral stimulation, visual imagery and verbal cognition, for example. The system efficiently produces improved educational results using psychological treatment techniques including, for example, Eye Movement Desensitization and Reprocessing (EMDR). In EMDR, cognitive components are concurrently presented to a patient, and the technique serves to restructure patient memories of traumatic events in a course of treatment. The system advantageously uses these techniques to structure the placement of new concepts into memory for better storage and retrieval of new material.

The system provides a computer-based training function based upon psychological techniques for managing memory and anxiety. It provides quick and effective training that ensures deep comprehension of material in a shortened timeframe. This may be useful in classrooms with a large number of students with disparate abilities and attitudes toward learning new material; business or educational circumstances where students or product users reside in remote areas where hands-on instruction is difficult; educational scenarios with students requiring additional assistance who cannot afford one-on-one tutoring; situations where a student experiences anxieties or other emotional barriers to learning a particular subject; and times when students wish to accelerate learning new material, for example.

In EMDR, four cognitive components are concurrently processed by the client, for example and the technique serves to restructure patient memories of traumatic events in a highly efficient course of treatment. EMDR has also been used successfully for some clients in support of improved creative output. The system supports structuring the placement of new concepts into memory for better storage and retrieval of new material, as well as the reduction in cognitive barriers to learning a particular topic. The employed psychological technique combines different stimuli to efficiently and effectively establish new concepts in memory. As experienced with the use of EMDR in psychological treatment, the combination of the four types of stimuli (eye movements, bilateral stimulation, visual imagery and verbal cognition) provides a power therapy for reprocessing traumatic memories in a short-term but long-lasting method and are advantageously used in a cognitive system to organize new material to place it into memory for effective retrieval at a later time.

The system can be used to present new material to a learner. The material is presented in both a verbal and visual method concurrently, combined with a tapping sound that alternates from left to right and/or light stimulation on screen that follows the same pattern. The visual or auditory bilateral stimulation occurs while a user employs the system to view material for short periods, e.g., 1-2 minutes, with short 1-2 minute breaks between. Material presented in each session builds on a prior one to make connections in memory and expand a knowledge base of the information. The learner may choose to repeat steps or bursts of material prior to progressing to a new image or set of data. The system facilitates construction of new memories, or stored stimuli, that can be retrieved for later use.

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor may comprise a combination of, hardware, firmware, and/or software.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, subroutine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UI), as used herein, comprises one or more display images, generated by a display processor and enabling user interaction with a processor or other device and associated data acquisition and processing functions. The UI also includes an executable procedure or executable application. The executable procedure or executable application conditions the display processor to generate signals representing the UI display images. These signals are supplied to a display device which displays an image for viewing by the user. The executable procedure or executable application further receives signals from user input devices, such as a keyboard, mouse, light pen, touch screen or any other means allowing a user to provide data to a processor. The processor, under control of an executable procedure or executable application manipulates the UI display images in response to the signals received from the input devices. In this way, the user interacts with a display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity. Workflow comprises a sequence of tasks performed by a device or worker or both. An object or data object comprises a grouping of data, executable instructions or a combination of both or an executable procedure.

Technicians and clinicians working at a healthcare organization need to learn how to use a new piece of diagnostic equipment or clinical system software requiring complex interaction. The usage of the equipment or software is related to life threatening or sustaining diagnosis or treatment of patients in a healthcare facility. Given the complexity of the operation and the potential risk of misuse of the equipment or software, a technician needs to become familiar with operating the system and feel comfortable with its use. A healthcare organization chooses to implement a computer-based training program to ensure new users of the equipment or software effectively learn to use the system. Users may have hands-on training from product representatives on the equipment or software, but the computer-based training program provides additional time for users to familiarize themselves with system operation. In addition, as new employees who do not receive hands-on product training begin working with the equipment or software, they need an efficient and effective method to learn its operation and potential risks of its misuse.

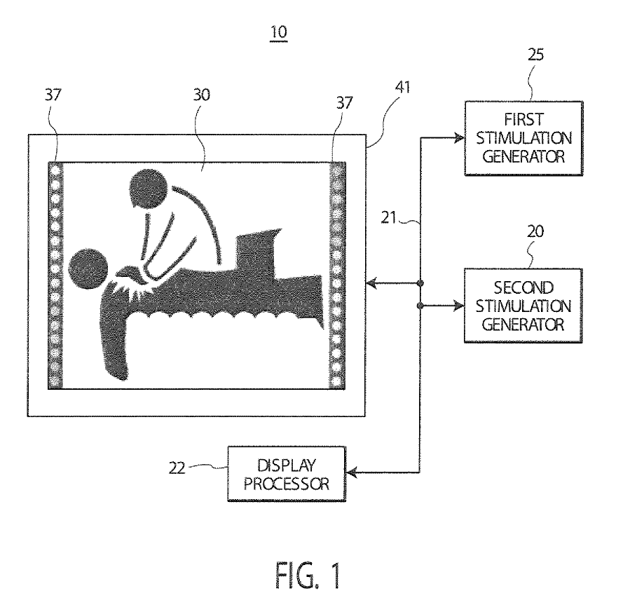

FIG. 1 shows automated, cognitively enhanced education system 10 including display processor 22, for providing data representing at least one display image 30 presenting information to be learnt by a user on workstation 41. The units of system 10 bidirectionally communicate via network 21. First stimulation generator 25 automatically generates visual data for display in the at least one display image 30 for providing bilateral visual stimulation to the user prompting the user to visually scan the information in the at least one display image 30 in at least one of, (a) a vertical and (b) horizontal, direction. Display image 30 provides a visual presentation of the information. Lights 37 comprising the bilateral visual stimulation on the left and right of display image 30 turn on and off in an alternating pattern with the brighter lights towards the bottom left and top right. Second stimulation generator 20 automatically generates speech representative data concerning the information for reproduction and provision to the user concurrently with presentation of the information and visual data to the user. The speech representative data provides a clear and simple description of the displayed information, for example. The visual data displayed in at least one display image 30 comprises visual indications alternating in at least one of, (a) brightness, (b) color, (c) position, (d) shade and (e) pattern. The speech representative data comprises visual text displayed in the at least one display image 30 and may also comprise audio data for sound reproduction to the user. Further, the concurrently provided information, visual data and speech representative data is presented for a limited and predetermined time period. In response to expiration of the limited and predetermined time period the provided information, visual data and speech representative data is removed and at least one display image 30 is provided including an image for testing user recall of said information.

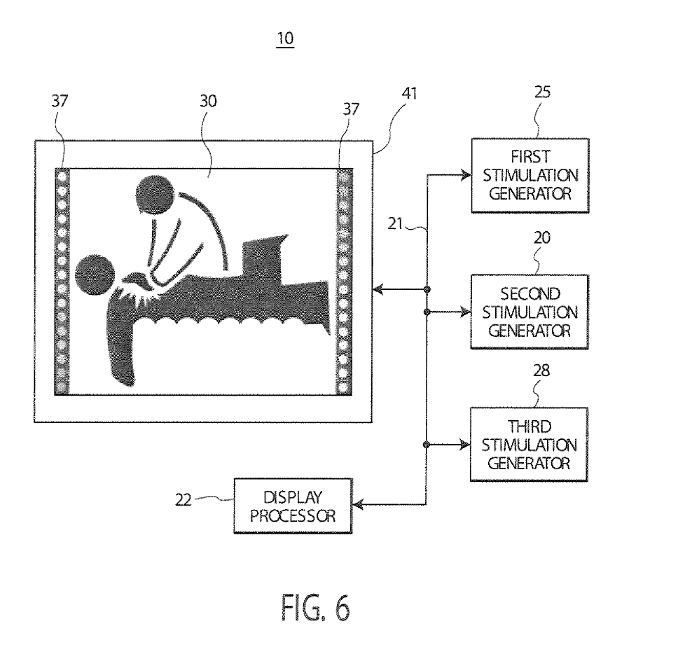

In another embodiment shown in FIG. 6 first stimulation generator 25 automatically generates text concerning the information for presentation in the at least one display image 30. Further, second stimulation generator 20 may also comprise an audio generator that automatically generates audio data for sound reproduction for providing bilateral audible stimulation (e.g., providing reproduced speech concerning the information or tapping sound, for example) to the user concurrently with presentation of the information, text and the audio data to the user for a predetermined limited period. In response to expiration of the predetermined limited time period display processor 22 provides data representing a display image for testing user recall of the information. Third stimulation generator 28 automatically generates visual data for display in the at least one display image 30 for providing bilateral visual stimulation to the user prompting the user to visually scan the information in the at least one display image 30 in at least one of, (a) a vertical and (b) horizontal, direction.

Automated education system 10 (FIGS. 1 and 6) employed in teaching use of a hospital information system, shows images of system operation shown on workstation 41 along with textual description of its use. Because of the high risk to patients, the high cost of errors associated with misuse, and limited time available for training users, the education system needs to be both efficient and effective in conveying the instructions necessary to understand system operation. The hospital organization provides access to system 10 to each technician who uses the equipment prior to the individual operating the system with patients. Users can also repeat the training as desired. Training can occur at any time that the users are available to operate automated system 10, rather than requiring a schedule that brings a human trainer together with one or more users.

For an instructor, automated education system 10 presents a simple user interface to complete a set of tasks including selecting a graphical image from disk storage, recording a verbal explanation of the material associated with that image and entering text to identify that image. A user can save the entered data, update the entries with replacement graphics or edited text, re-sequence the entries, and remove any incorrect ones. A user also previews lessons as they are to be presented to student users via workstation 41. An instructor creates navigation links for different navigation paths from one image to the next, depending upon a user selected self-assessment for comfort with the material presented. System 10 provides a set of initial cognitive beliefs for this self-assessment and an instructor can add to this list. A student begins a specific training session by selecting from a set of cognitions or beliefs regarding his/her comfort with the new material, or enters his/her own belief statement. The user specifies how s/he feels, e.g., “I cannot perform complex tasks” or “I cannot learn mathematics” and rates how strongly s/he believes this statement using the Validity of Cognition scale from 1-7 (1=not at all credible; 7=very credible). The system stores this initial belief concerning user capacity to learn the subject matter and begins the lesson for the student.

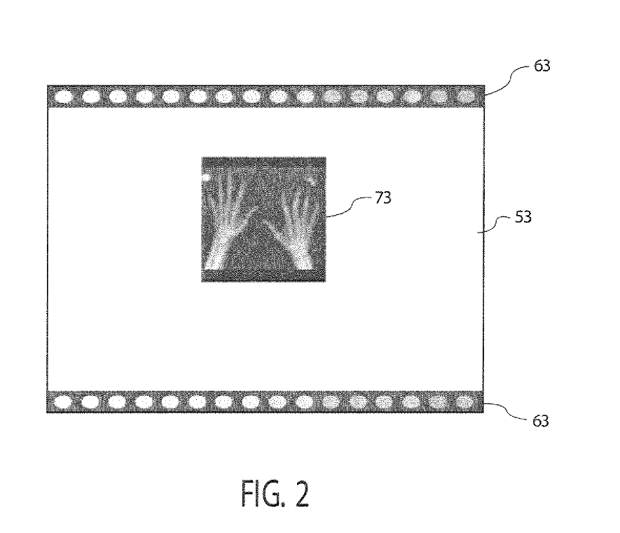

System 10 presents images, audible text and bilateral light stimulation in limited bursts, such as between 60 and 120 seconds, for example. In one embodiment, an optional audible bilateral signal is provided, such as a low volume clicking or tapping sound alternating from a left to a right speaker. After the presentation, system 10 provides a silent and empty screen pause of 60 to 120 seconds. The material presented initially is a simple concept and each subsequent burst presents a slightly modified concept with new material that builds on the preceding concepts. The total time to present the material depends upon the content, but typically does not exceed 30 minutes per lesson. FIGS. 1 and 2 show exemplary display image layouts 30 and 53 respectively presented on workstation 41. In display image 30 lights 37 appear on the left and right of the screen for providing bilateral visual stimulation to the user prompting the user to visually scan the information in the at least one display image 30 in a bottom left to top right direction, for example. Alternative horizontal, diagonal or other orientation of the lights (or other visual indicator such as flashing, shading, highlighting or other visual variation of display elements) may be used to direct a user in visually scanning displayed information in a particular direction of orientation.

FIG. 2 shows display image 53 provided by automated, cognitively enhanced education system 10 in which lights 63 scan (i.e., turn on and off and appear to move) horizontally (e.g., left to right). This light orientation may provide a stronger bilateral action of the eyes. Image 53 includes a single displayed image window 73 together with text to describe image 73 and related data such as data indicating available user interactions etc. Each step in the lessons has an image and associated text to provide learning material to the student user. Images may be drawings or photographs or other digital images reproduced from ancillary equipment and software not part of system 10, for example. At points pre-determined by an instructor lesson plan, system 10 presents the instructor with the same question initially asked about user belief in his/her ability to learn or use the new material. Based upon a user current selection and rating, system 10 may repeat prior material presented, select a particular path to continue, or complete the current lesson.

System 10 provides a visual as well as auditory presentation including in one embodiment, stereo audio capability to provide alternating left and right auditory signals. In this embodiment, as an alternative to bilateral video stimulation, bilateral auditory stimulation (e.g., repetitive (such as tapping) sound or recorded text) is employed. A further embodiment provides concurrent visual and auditory bilateral stimulation. An administrative or instructional user is able to add “lessons” to a data base, which stores audio, textual and graphical material for presentation to a student. A user interface display image 30 (FIG. 1) for an instructor is used to add these lessons, recording audio explanations or topic descriptions, linking the pictures to the text, and setting the sequence of presentation. System 10 has an interface for acquiring images in standard formats, such as .gif, .jpg or .bmp, which are selected from any storage media the application can access. System 10 includes software or hardware functions (or combination thereof) to create or acquire these images, and is compatible with industry standard methods.

Input data provided to system 10 used to provide display images 30 and accompanying audio presenting information being taught include, text labels for images, text lesson descriptions and content and audible text recordings of lesson description and content. Input data provided to system 10 (or stored in a repository in system 10) includes identification of an association between images and accompanying text, identification of a sequence for each lesson step and identification of a collection or sequence of lessons in a curriculum. System 10 stored information also includes lesson and curriculum identifiers as well as text descriptions of potential cognitive beliefs and text questions and response options for post-lesson learner assessment. System 10 further operates in response to instructions and preconfigured preferences for lesson setup including timing of pause between lessons and relative timing of auditory and visual bilateral stimulation, sequence of steps within a lesson, sequence of lessons within a curriculum and steps within a lesson and where the student enters cognitive belief of ability to learn material. Further, system 10 determines alternative sequences of lessons based upon student response to a cognitive belief inquiry. Additional data acquired (and displayed in response to user command) by system 10 includes student identifying information, such as name, address, telephone, email address, date/time of lesson start and end, student preference for visual, auditory or combined bilateral stimulation method, student cognitive belief in ability to learn new material prior to beginning a lesson, student cognitive belief of ability to learn and understand new material after completing a lesson and student responses to individual post-lesson assessment queries.

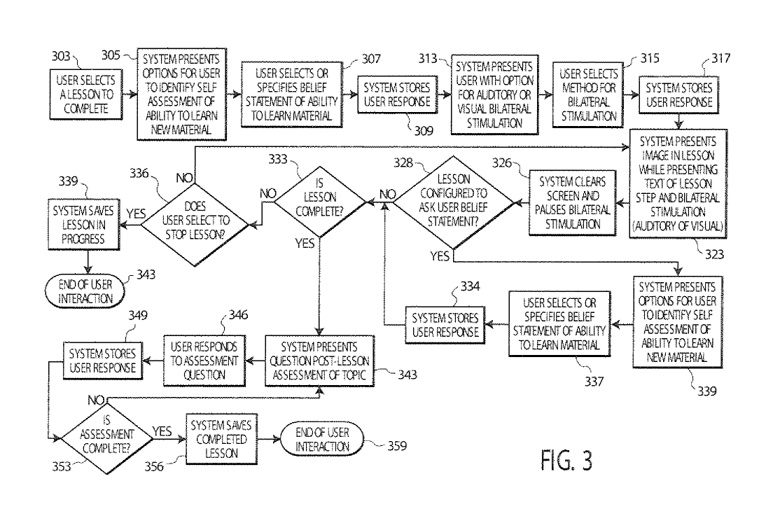

FIG. 3 shows a flowchart of a process employed by automated, cognitively enhanced education system 10 involving student user system interaction. In response to user selection of a lesson in step 303, system 10 provides options via workstation 41 enabling a user to enter a self assessment in the subject concerned in step 305 and in step 307 the user selects a statement indicating user ability to learn the subject. In step 309 system 10 stores the user response and in step 313 a user selects a method of bilateral stimulation in step 315 that is stored by system 10 in step 317. System 10 presents an image on workstation 41 in step 323 including the lesson information and text of the lesson as well as bilateral audio or video stimulation. System 10 clears the workstation 41 screen and pauses the bilateral stimulation in step 326. In step 328 it is determined if the lesson is configured to ask for a user belief statement. If not, in step 333 it is determined if the lesson is complete, if not it is determined if a user desires to stop the lesson in step 336 and if so, system 10 saves the lesson progress in step 339 and user interaction ends in step 343. In step 333, if it is determined if the lesson is complete, system 10 presents a post-lesson assessment question in step 343. A user responds to the question in step 346 and system 10 stores the response in step 349. If it is determined the assessment is complete in step 353, the completed lesson is stored in step 356 and user interaction ends in step 359. If the assessment is not complete in step 359, the assessment continues with step 343. In step 328, if it is determined a user belief statement is to be requested, system 10 presents a user with options to enter a self assessment of user ability to learn the material in step 339. A user selects an option indicating the user belief assessment in step 337 which is stored in step 334 and processing continues with step 333.

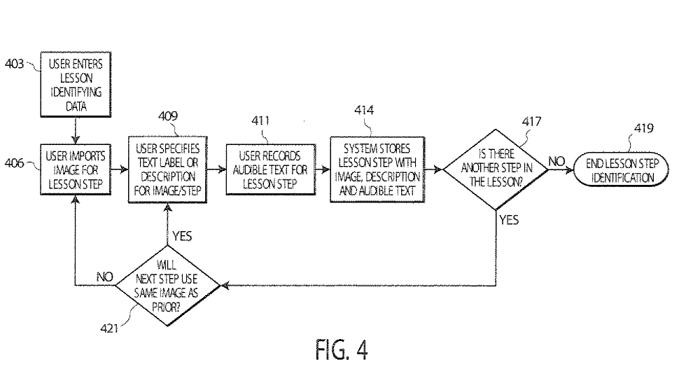

FIG. 4 shows a flowchart of a process employed by automated, cognitively enhanced education system 10 involving teacher user interaction for lesson step identification. A user imports a lesson image (e.g., a graphic file) in step 406 in response to user selection of lesson identification data in step 403. A user enters data indicating a text label or description for the lesson and associated image in step 409 and records audible text for the lesson in step 411 which is stored by system 10 in step 414. If it is determined there is another lesson step in step 417, the process returns to step 406 or 409 dependent on whether the lesson uses the present image or a new image as determined in step 421. If there is no other lesson step the lesson step process ends in step 419. System 10 acquires and stores images, recorded voice text entered via a recording system interface, text for individual step content within a lesson and data indicating a sequence of lessons within a curriculum. System 10 also acquires and stores a textual list of pre-lesson, mid-lesson and post-lesson cognitive beliefs, preferences for lesson timing, step sequence, presentation of cognitive belief queries, presentation of post-lesson assessments as well as student preference for visual, auditory or combined bilateral stimulation method.

System 10 also provides display images on workstation 41 enabling a user to edit data (e.g., add, remove, amend, copy, re-sequence, delete, preview lessons or steps in a lesson or curriculum and link lessons and edit assessments and cognitive beliefs) stored in a lesson definition, including images, recorded voice or typed text labels and descriptions and textual list of cognitive beliefs. System supports printing a lesson with step numbers and images. The lesson steps are presented individually on workstation 41 together with predetermined bilateral stimulus, visual image and text description of the step following presentation of cognitive belief options prior to the lesson. System 10 further supports user initiated pauses between step presentation based upon predetermined timing preferences and pauses in lessons as selected by a student as well as enabling a student to resume a prior lesson step and also records start and stop date/time for each lesson for each student user.

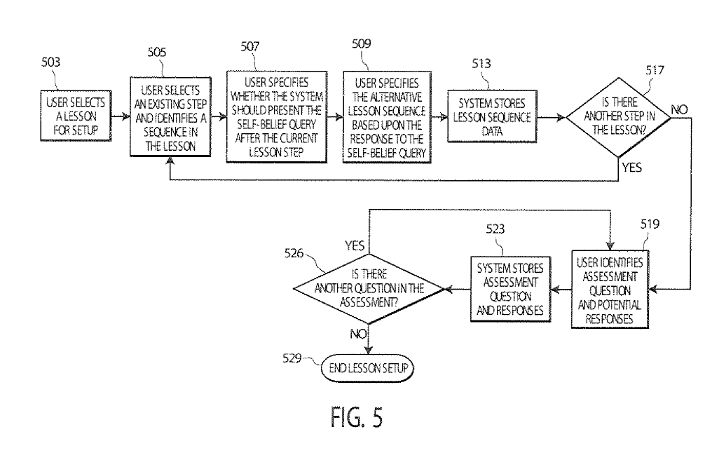

FIG. 5 shows a flowchart of a process employed by automated, cognitively enhanced education system 10 (FIG. 1) involving user (e.g., instructor) managed lesson setup interaction. Specifically, a user employs display images presented on workstation 41 enabling a user to select, a lesson to be configured in step 503, an existing step and a sequence in the lesson in step 505, whether a self-belief query is to be presented to a student after a current lesson step in step 507 and an alternative lesson sequence based upon a response to a self-belief query in step 509. System 10 in step 513 stores the entered data in a repository. In step 517, system 10 determines if there is another step in the lesson and if so, repeats steps 505, 507, 509 and 513 until the steps in the lesson are processed in which case the process continues with step 519. In step 519 a user selects an assessment question and associated potential responses which are stored in step 523. Steps 519 and 523 are repeated until the assessment questions and associated responses are selected as determined in step 526 and the lesson configuration ends in step 529. System 10 enables a student to view new or unfamiliar material in lesson groupings at a selected pace and view an introductory (and summary) section for each lesson that does not use the timing and bilateral stimulation of the lesson. A student is able to also choose to move forward from the introductory section into the lesson steps at his/her own choice, review lessons previously viewed and select whether or not to have bilateral stimulation as auditory, visual or both. A student is able to stop a lesson without completing it, in which case the system records the time spent on the lesson and is able to resume at any lesson step. A student is able to see a status of lessons as not started, in progress and completed and identify the current step number in view and the total steps in a lesson in progress.

System 10 supports a user in building new, complex memories in a shorter time than other systems and the information is easier to retrieve and may be retained longer than current training software systems. System 10 comprises a modular framework for a variety of teaching scenarios. In another embodiment the presentation of images or visual displays, for example, is replaced with three-dimensional presentations using computer-aided design programs or virtual reality systems, for example, to allow the user experience to become more realistic. System 10 in one embodiment incorporates a rules engine for evaluating a student cognitive belief rating to determine which steps in a lesson are to be presented and in which sequence. The evaluation component enables a user to manipulate a particular object or try to accomplish a task using the computer software and hardware. In particular, coupling of a virtual reality presentation of material and user interaction improves results for expected learning outcomes. Further, stored results of student assessments are reported and used to provide feedback to a teacher to improve the lesson content and setup.

A student, whether in an educational (primary, secondary or post-secondary) or business setting, needs to learn complex new material in a short time. The student may not have an instructor who has the time to present the content and work with the student to ensure comprehension. This may occur, for example, when a new product is delivered to a large organization, such as a multi-entity healthcare facility, and users have experienced minimal or sporadic use of that product. If training is hard to complete due to schedules of trainers and users, and the risks of making mistakes when using that product are high, a computer-based training (CBT) program is of value in supporting training requirements. However, given time constraints for a new user, CBT needs to be highly effective, or it may not be useful. System 10 provides quick and effective training that ensures deep comprehension of material in a shortened timeframe. System 10 is also useful in classrooms with a large number of students with disparate abilities, students in remote areas where hands-on instruction is difficult, students requiring additional assistance who cannot afford one-on-one tutoring and students who wish to accelerate learning material on their own in a non-classroom setting.

The system and processes of FIGS. 1 and 3-6 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. System 10 may be used in any setting that requires education or training and is not limited to healthcare or information systems fields. The EMDR technique is also usable in psychological testing settings, for example. System 10 advantageously concurrently combines use of multiple cognitive processes including techniques effective in other psychological settings related to memory. The processes and applications may in alternative embodiments, be located on one or more (e.g., distributed) processing devices accessing a network linking the elements of FIG. 1. Further, any of the functions and steps provided in FIGS. 1 and 3-6 may be implemented in hardware, software or a combination of both and may reside on one or more processing devices located at any location of a network linking the elements of FIG. 1 or another linked network including the Internet.

What is claimed is:

1. A processing device implemented and automated, cognitively enhanced education system, comprising:
a display processor for providing data representing at least one display image presenting information to be learnt by a user;
a first stimulation generator for automatically generating visual data for display in said at least one display image for providing bilateral visual stimulation to said user prompting said user to visually scan said information in said at least one display image in at least one of, (a) a vertical and (b) horizontal, direction; and
a second stimulation generator for automatically generating speech representative data concerning said information for reproduction and provision to said user concurrently with presentation of said information and visual data to said user.

2. The system according to claim 1, wherein
said visual data for display in said at least one display image comprises visual indications alternating in at least one of, (a) brightness, (b) color, (c) position, (d) shade and (e) pattern.

3. The system according to claim 1, wherein
said speech representative data comprises visual text displayed in said at least one display image.

4. The system according to claim 1, wherein
said speech representative data comprises audio data for sound reproduction to said user.

5. The system according to claim 1, wherein
the concurrently provided information, visual data and speech representative data is presented for a limited and predetermined time period.

6. The system according to claim 5, wherein
in response to expiration of said limited and predetermined time period said provided information, visual data and speech representative data is removed.

7. The system according to claim 6, wherein
in response to expiration of said limited and predetermined time period, at least one display image is provided including an image for testing user recall of said information.

8. The system according to claim 1, wherein
said at least one display image includes an image for testing user recall of said information.

9. A processing device implemented and automated, cognitively enhanced education system, comprising:
a display processor for providing data representing at least one display image presenting information to be learnt by a user;
a first stimulation generator for automatically generating text concerning said information for presentation in said at least one display image; and
a second stimulation generator for automatically generating audio data for sound reproduction for providing bilateral audible stimulation to said user concurrently with presentation of said information, text and said audio data to said user for a predetermined limited period and in response to expiration of said predetermined limited time period, said display processor provides data representing a display image for testing user recall of said information.

10. The system according to claim 9, wherein
said second stimulation generator for automatically generating audio data for sound reproduction generates at least one of, (a) a repetitive sound or (b) a recorded text reproduction.

11. The system according to claim. 10, wherein
said repetitive sound comprises a tapping sound.

12. The system according to claim 9, including
a third stimulation generator for automatically generating visual data for display in said at least one display image for providing bilateral visual stimulation to said user prompting said user to visually scan said information in said at least one display image in at least one of, (a) a vertical and (b) horizontal, direction.

13. A processing device implemented and automated, cognitively enhanced education system, comprising:
a display processor for providing data representing at least one display image presenting information to be learnt by a user;
a visual stimulation generator for automatically generating visual data for display in said at least one display image for providing bilateral visual stimulation to said user prompting said user to visually scan said information in said at least one display image in at least one of (a) a vertical and (b) horizontal, direction; and
an audio generator for automatically providing reproduced speech concerning said information to said user concurrently with presentation of said information and said visual data to said user.
